(19) United States
(12) Patent Application Publication
(10) Pub. No.: US 2021/0357842 A1
(43) Pub. Date: Nov. 18, 2021

(54) SYSTEMS AND METHODS FOR IMPROVING ELECTRONIC ENGAGEMENT BETWEEN A PARTICIPANT AND A SUPPORT PARTNER

(71) Applicant: Myroadmap, LLC, Provo, UT (US)

(72) Inventors: Kollyn Lund, Provo, UT (US); Spencer Rogers, Provo, UT (US); William Brian Woahn, Pleasant Grove, UT (US)

(21) Appl. No.: 17/318,197

(22) Filed: May 12, 2021

Related U.S. Application Data
(60) Provisional application No. 63/025,353, filed on May 15, 2020.

(51) Int. Cl. G06Q 10/06; G06Q 50/00

(52) U.S. Cl. CPC G06Q 10/06393; G06Q 50/01

(57) ABSTRACT

Examples relate to systems and methods for improving electronic engagement between a participant and a support partner in a computer-based personal development system. A system may include a processor and a memory coupled to the processor and containing computer-executable instructions that, when executed by the processor, cause the processor to perform acts. The acts performed by process may include coordinating display on a participant electronic device of a plurality of self-evaluation metrics and allowing a participant to select one of a positive evaluation option or a negative evaluation option for one or more self-evaluation metrics, coordinating display on a support partner electronic device of an electronic notification option for completion of a first self-evaluation metric, and transmitting to the participant electronic device an alert message requesting the participant select one of a positive evaluation option or a negative evaluation option for a first self-evaluation metric.

### CROSS-REFERENCE TO RELATED APPLICATIONS

This application claims priority to U.S. Provisional Patent Application No. 63/025,353 filed on May 15, 2020, the disclosure of which is incorporated herein, in its entirety, by this reference.

### BACKGROUND

Conventional personal development systems and methods may be used by participants to set goals and improve certain facets in the lives of participants. These conventional personal development systems and methods are often limited by engagement of the participants. Moreover, conventional personal development systems and methods typically do not provide the instantaneous support for participants struggling to progress.

### SUMMARY

Embodiments disclosed herein are related to systems and methods for improving electronic engagement between a participant and a support partner in a computer-based personal development system. In an embodiment, a system is disclosed. The system includes a processor and a memory coupled to the processor and containing computer-executable instructions. The computer-executable instructions, when executed by the processor, cause the processor to perform an act of coordinating display on a participant electronic device of a plurality of self-evaluation metrics. One or more self-evaluation metrics of the plurality of self-evaluation metrics include at least a positive evaluation option and a negative evaluation option displayed on the participant electronic device and configured to allow a participant to select one of the positive evaluation option or the negative evaluation option for the one or more self-evaluation metrics. The computer-executable instructions, when executed by the processor, cause the processor to perform an act of coordinating display on a support partner electronic device of a support partner dashboard indicating which self-evaluation metrics of the plurality of self-evaluation metrics have been completed by the participant on the participant electronic device. The computer-executable instructions, when executed by the processor, cause the processor to perform an act of coordinating display on the support partner electronic device of an electronic notification option for completion of a first self-evaluation metric of the plurality of self-evaluation metrics by the participant on the participant electronic device. The computer-executable instructions, when executed by the processor, cause the processor to perform an act of receiving communication from the support partner electronic device that a support partner has selected the electronic notification option. The computer-executable instructions, when executed by the processor, cause the processor to perform an act of transmitting to the participant electronic device an alert message requesting the participant select one of a positive evaluation option or a negative evaluation option for the first self-evaluation metric.

In an embodiment, a computer-implement method is disclosed. The computer-implemented method includes coordinating display on a participant electronic device of a plurality of self-evaluation metrics. One or more self-evaluation metrics of the plurality of self-evaluation metrics includes at least a positive evaluation option and a negative evaluation option displayed on the participant electronic device and configured to allow a participant to select one of the positive evaluation option or the negative evaluation option for the one or more self-evaluation metrics. The computer-implemented method also includes coordinating display on a support partner electronic device of a support partner dashboard indicating which self-evaluation metrics of the plurality of self-evaluation metrics have been completed by the participant on the participant electronic device. The computer-implemented method also includes coordinating display on the support partner electronic device of an electronic notification option for completion of a first self-evaluation metric of the plurality of self-evaluation metrics by the participant on the participant electronic device. The computer-implemented method also includes receiving communication from the support partner electronic device that a support partner has selected the electronic notification option. The computer-implemented method also includes transmitting to the participant electronic device an alert message requesting the participant select one of a positive evaluation option or a negative evaluation option for the first self-evaluation metric.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 is a schematic of a controller, according to an embodiment.

FIG. 2 is a self-evaluation metric displayed on a participant electronic device, according to an embodiment.

FIG. 3 is a bar and sliding tab of a self-evaluation metric displayed on a participant electronic device, according to an embodiment.

FIG. 4A is a support partner dashboard displayed on a support partner electronic device, according to an embodiment.

FIG. 4B is a summary of at least some of a plurality of self-evaluation metrics for a participant displayed on a support partner electronic device, according to an embodiment.

FIG. 5 is a self-evaluation metric displayed on a participant electronic device, according to an embodiment.

FIG. 6 is a progress report displayed on a participant electronic device, according to an embodiment.

FIG. 7 is a flow diagram of a method for improving electronic engagement between a participant and a support partner, according to an embodiment.

### DETAILED DESCRIPTION

Embodiments disclosed herein are related to systems and methods for improving electronic engagement between a participant and a support partner in a computer-based personal development system. Systems and methods described herein may be used by a participant and a success partner. The participant in the systems and methods described herein may include an individual that is striving to improve in one or more success metrics (e.g., self-evaluation metrics and/or desired outcomes or objectives). The success partner may include an individual that has a relationship with the participant and/or is in a position to help the participant achieve the one or more success metrics. The computer-based personal development system may include various categories of success metrics that the participant is working to improve upon or attain. The computer-based personal development system may support a relationship between at least the participant and the success partner where connection, engagement, communication, assessment, education, and/or accountability are utilized to achieve the success metrics. Embodiments described herein may provide instant electronic engagement for a participant when the controller determines a participant is in need of assistance. In some embodiments, an administrator may include an individual or organization that works with the support partner to ensure that the support partner is consistent in mentoring and/or engaging with the participant(s). Specific success metrics of the computer-based personal development system may be written to be unique for various individuals and/or circumstances.

The computer-based development system may be used between two or more parties (e.g., the participant, the support partner, and/or one or more third parties) to supports a relationship where connection, engagement, communication, assessment, education and accountability are utilized to achieve one or more success metrics defined and agreed upon by the two or more parties. In some embodiments, the computer-based personal development system may include success metrics specific to a particular niche or relationship. Examples of relationships supported by the computer-based development system described herein include, but are not limited to, a coach and a client, a counselor (e.g., therapist, psychologist, or other mental health provider) and a patient, a sales manager and an account executive, a direct marketing manager and a door-to-door sales representative, a manager and a sales representative associated with multi-level marketing organization, a parent and a child, an individual and a friend, a husband and a wife, a supervisor and an employee, a broker (e.g., real estate, mortgage, or insurance) and an agent (e.g., real estate, mortgage, or insurance), a school counselor and a student, an employer and an employee, and/or peer to peer. In some embodiments, the computer-based personal development system may be used with and include success metrics specific to: parents dealing with autistic children, ADHD, depression, anxiety, bullying, sexual abuse, suicide ideation, gender orientation, difficulty in relationships and other mental health disorders and issues; substance and alcohol abuse and/or addiction; men or women dealing with betrayal trauma; men or women with sexual addiction, including pornography addiction; individuals grieving from loss of a loved one; individuals having addiction(s) to social media and technology; individuals recovering from sex trafficking; veterans suffering post-traumatic stress disorder and other mental health trauma; women suffering from post-partum depression; individuals suffering from adoption and separation anxiety; youth coping with divorce of parents; individuals recovering from rape and/or sexual abuse; and/or individuals suffering from domestic violence.

For purposes of this document, the relationship will be defined by a participant having a participant electronic (e.g., computing) device and a support partner having a support partner electronic (e.g., computing) device. Many implementations of computer-based personal development system may be used on multiple platforms including applications on desktop computer, laptops, mobile electronic devices (e.g., smartphones), tablets electronic device, and/or cloud-based servers. The participant may utilize the computer-based personal development system through a participant electronic device, and the support partner may utilize the computer-based personal development system through a support partner electronic device.

The computer-based personal development system may include success metrics (e.g., self-evaluation metrics) that are developed and agreed upon by the participant and the support partner. In some embodiments, the participant performs a self-assessment using the success metrics on the participant electronic device using one of a variety of methods or options. For example, green, yellow, and red color coded options may be displayed on the participant electronic device. The color code options may be based on statements that define the state of the participant with regards to progress made towards the particular success metric. In some embodiments, the green color option is associated with a positive evaluation option, the red color option is associated with a negative (e.g., need help) evaluation option, and the yellow color option is associated with intermediate evaluation option between the negative and positive evaluation options. The support partner can then, on the support partner computing device, agree or disagree with the participant assessment and provide information supporting his or her reasoning. The support partner can provide content to the participant via the participant computing device to assist the participant in moving from a red to a yellow and ultimately to a green state. The assessments may be based on both quantitative and qualitative data and information.

In some embodiments, the computer-based personal development system may be configured to: identify and improve connection and engagement between a participant and a support partner, facilitate and perform qualitative analysis of a given engagement and/or a participant/support partner relationship; articulate institutional, group, and/or individual success metrics; aggregate qualitative data about progress towards a preselected desired outcome or objective; facilitate communication between a participant and support partner within a given context; define support partner standards and/or guidelines to reduce intentional or unintentional insertion of personal bias in the relationship between the support partner and the participant relationship in the computer-based personal development system; crowdsource a set of desired behaviors that lead to a desired outcome; allow collaborative editing of content and structure by users; aggregate and share success metric of various computer-based personal development systems; facilitate communication between parties about progress towards a given set of success metrics; facilitate communication between parties in what may be, or may be perceived to be by one or more of the parties, a strained or otherwise awkward, uncomfortable or threatening context; and/or utilize artificial intelligence to connect a participant and success partner to one another with the objective of increasing the probability that the participant will achieve or have a positive outcome with the success metrics.

In some implementations, the computer-based personal development system may be internet-based for participants to use to perform a self-assessment and to compare themselves against other participants having common success metrics. The computer-based personal development system may allow participants to use educational tools within a library on the computer-based personal development system to improve skills, behaviors, and abilities to achieve a positive outcome on the success metrics. In some embodiments, if participants are not able to achieve positive outcomes on the success metrics, the participants may be given the opportunity to engage with professionals that can assist the participants to achieve positive outcomes with their success metrics. Specific success metrics in the computer-based personal development system for certain individuals, circumstances, uses, etc., may be stored in a library or database and cataloged by the computer-based personal development system for future use by other participants.

In some embodiments, the computer-based personal development system may be configured to gathering anonymous data from participants, success partners, or other user to improve the computer-based personal development system and determine what methods work best to assist participants to achieve a positive outcome with selected success metrics. Data may be accumulated on the computer-based personal development system, and the computer-based personal development system may use the data for data mining purposes by artificial intelligence (AI) for any of the determinations made by the controller, described in greater detail below.

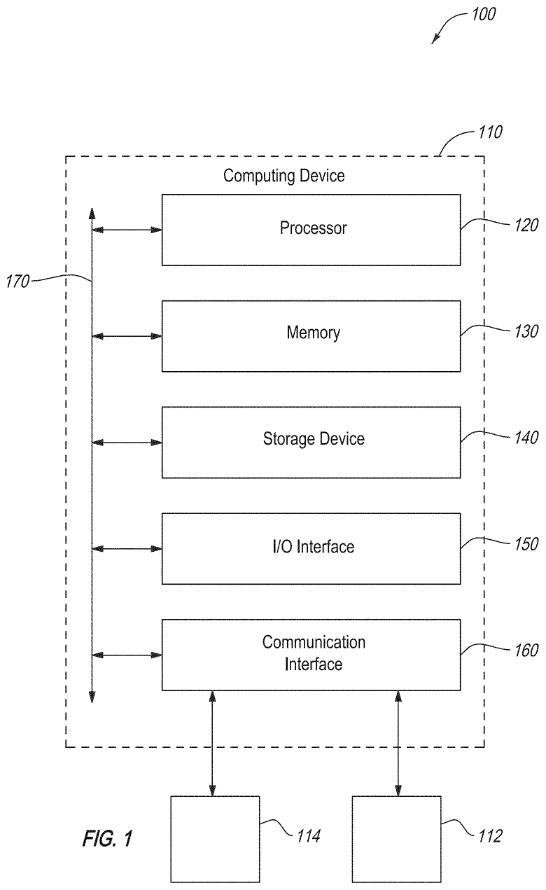

Turning to FIG. 1, any of the computer-based personal development systems described herein may be used to carry out any of the example methods disclosed herein, such as using a controller. FIG. 1 is a schematic of a controller 100 for executing any of the example methods and computer-based personal development systems disclosed herein, according to an embodiment. The controller 100 may be configured to implement any of the example methods disclosed herein, such as the method 700. The controller 100 includes at least one computing device 110. The at least one computing device 110 is an exemplary computing device that may be included with the computer-based personal development systems and/or configured to perform one or more of the acts described below, such as the method 700. The at least one computing device 110 can include one or more servers, one or more computers (e.g., desk-top computer, lap-top computer), or one or more mobile computing devices (e.g., smartphone, tablet, etc.). The computing device 110 can comprise at least one processor 120, memory 130, a storage device 140, an input/output (“I/O”) device/interface 150, and a communication interface 160. While an example computing device 110 is shown in FIG. 1, the components illustrated in FIG. 1 are not intended to be limiting of the controller 100 or computing device 110. Additional or alternative components may be used in some examples. Further, in some examples, the controller 100 or the computing device 110 can include fewer components than those shown in FIG. 1. For example, the controller 100 may not include the one or more additional computing devices 112, 114. In some examples, the at least one computing device 110 may include a plurality of computing devices, such as a server farm, computational network, or cluster of computing devices. Components of computing device 110 shown in FIG. 1 are described in additional detail below.

In some examples, the processor(s) 120 includes hardware for executing instructions (e.g., instructions for carrying out one or more portions of any of the methods disclosed herein), such as those making up a computer program. For example, to execute instructions, the processor(s) 120 may retrieve (or fetch) the instructions from an internal register, an internal cache, the memory 130, or a storage device 140 and decode and execute them. In particular examples, processor(s) 120 may include one or more internal caches for data such as look-up tables. As an example, the processor(s) 120 may include one or more instruction caches, one or more data caches, and one or more translation lookaside buffers (TLBs). Instructions in the instruction caches may be copies of instructions in memory 130 or storage device 140. In some examples, the processor 120 may be configured (e.g., include programming stored thereon or executed thereby) to carry out one or more portions of any of the example methods and systems disclosed herein.

In some examples, the processor 120 is configured to perform any of the acts disclosed herein such as in method 700 or cause one or more portions of the computing device 110 or controller 100 to perform at least one of the acts disclosed herein. Such configuration can include one or more operational programs (e.g., computer program products) that are executable by the at least one processor 120.

The at least one computing device 110 (e.g., a server) may include at least one memory storage medium (e.g., memory 130 and/or storage device 140). The computing device 110 may include memory 130, which is operably coupled to the processor(s) 120. The memory 130 may be used for storing data, metadata, and programs for execution by the processor(s) 120. The memory 130 may include one or more of volatile and non-volatile memories, such as Random Access Memory (RAM), Read Only Memory (ROM), a solid state disk (SSD), Flash, Phase Change Memory (PCM), or other types of data storage. The memory 130 may be internal or distributed memory.

The computing device 110 may include the storage device 140 having storage for storing data or instructions. The storage device 140 may be operably coupled to the at least one processor 120. In some examples, the storage device 140 can comprise a non-transitory memory storage medium, such as any of those described above. The storage device 140 (e.g., non-transitory storage medium) may include a hard disk drive (HDD), a floppy disk drive, flash memory, an optical disc, a magneto-optical disc, magnetic tape, or a Universal Serial Bus (USB) drive or a combination of two or more of these. Storage device 140 may include removable or non-removable (or fixed) media. Storage device 140 may be internal or external to the computing device 110. In some examples, storage device 140 may include non-volatile, solid-state memory. In some examples, storage device 140 may include read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these. In some examples, one or more portions of the memory 130 and/or storage device 140 (e.g., memory storage medium(s)) may store one or more databases thereon.

In some examples, data related to the computer-based personal development system may be stored in a memory storage medium such as one or more of the at least one processor 120 (e.g., internal cache of the processor), memory 130, or the storage device 140. In some examples, the at least one processor 120 may be configured to access (e.g., via bus 170) the memory storage medium(s) such as one or more of the memory 130 or the storage device 140. For example, the at least one processor 120 may receive and store the data (e.g., look-up tables) as a plurality of data points in the memory storage medium(s). The at least one processor 120 may execute programming stored therein adapted access the data in the memory storage medium(s). For example, the at least one processor 120 may access one or more look-up tables in the memory storage medium(s) such as memory 130 or storage device 140.

The computing device 110 also includes one or more I/O devices/interfaces 150, which are provided to allow a user to provide input to, receive output from, and otherwise transfer data to and from the computing device 110. These I/O devices/interfaces 150 may include a mouse, keypad or a keyboard, a touch screen, camera, optical scanner, network interface, web-based access, modem, a port, other known I/O devices or a combination of such I/O devices/interfaces 150. The touch screen may be activated with a stylus or a finger.

The I/O devices/interfaces 150 may include one or more devices for presenting output to a user, including, but not limited to, a graphics engine, a display (e.g., a display screen or monitor), one or more output drivers (e.g., display drivers), one or more audio speakers, and one or more audio drivers. In certain examples, I/O devices/interfaces 150 are configured to provide graphical data to a display for presentation to a user. The graphical data may be representative of one or more graphical user interfaces and/or any other graphical content as may serve a particular implementation.

The computing device 110 can further include a communication interface 160. The communication interface 160 can include hardware, software, or both. The communication interface 160 can provide one or more interfaces for communication (such as, for example, packet-based communication) between the computing device 110 and one or more additional computing devices 112, 114 or one or more networks. For example, communication interface 160 may include a network interface controller (NIC) or network adapter for communicating with an Ethernet or other wire-based network or a wireless NIC (WNIC) or wireless adapter for communicating with a wireless network, such as a WI-FI. In some embodiments, the additional computing device 112 may include the participant electronic device 112 and the additional computing device 114 may include the support partner electronic device 114. The additional computing device 112, 114 may include an aspect of the controller 100.

Any suitable network and any suitable communication interface 160 may be used. For example, computing device 110 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, one or more portions of controller 100 or computing device 110 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof. Computing device 110 may include any suitable communication interface 160 for any of these networks, where appropriate.

The computing device 110 may include a bus 170. The bus 170 can include hardware, software, or both that couples components of computing device 110 to each other. For example, bus 170 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

It should be appreciated that any of the examples of computer-based personal development systems and/or acts described herein, such as in the method 700 may be performed by and/or at the computing device 110.

In some embodiments, the controller 100 is configured to perform an act of coordinating display on a participant electronic device 112 of a plurality of self-evaluation metrics (e.g., success metrics). The plurality of self-evaluation metrics may be divided into multiple groups (e.g. roadmaps) of self-evaluation metrics, and each group of self-evaluation metrics may be further subdivided into multiple stages of self-evaluation metrics. One or more self-evaluation metrics of the plurality of self-evaluation metrics may include at least a positive evaluation option and a negative evaluation option displayed on the participant electronic device 112. In some embodiments, each self-evaluation metric of the plurality of self-evaluation metrics includes at least a positive evaluation option and a negative evaluation option displayed on the participant electronic device 112. When displayed on the participant electronic device 112, a participant is allowed to select one of the positive evaluation option or the negative evaluation option for each of the one or more self-evaluation metrics. In some embodiments, the controller 100 also is configured to coordinate display on the participant electronic device 112 of an intermediate self-evaluation option between the positive evaluation option and the negative evaluation option for the one or more self-evaluation metrics.

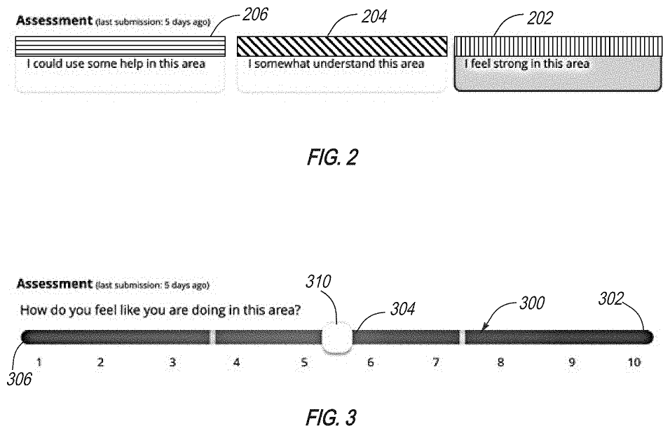

FIG. 2 is a screenshot 200 on a portion of the participant electronic device 112 displaying a self-evaluation metric including a positive evaluation option 202, an intermediate option 204, and a negative evaluation option 206. In some embodiments, the evaluation options may be color coded. For example, when displayed on the participant electronic device 112, the positive evaluation option 202 may be green (represented by vertical lines), the intermediate evaluation option 204 may be yellow (represented by diagonal lines), and the negative evaluation option 206 may be red (represented by horizontal lines).

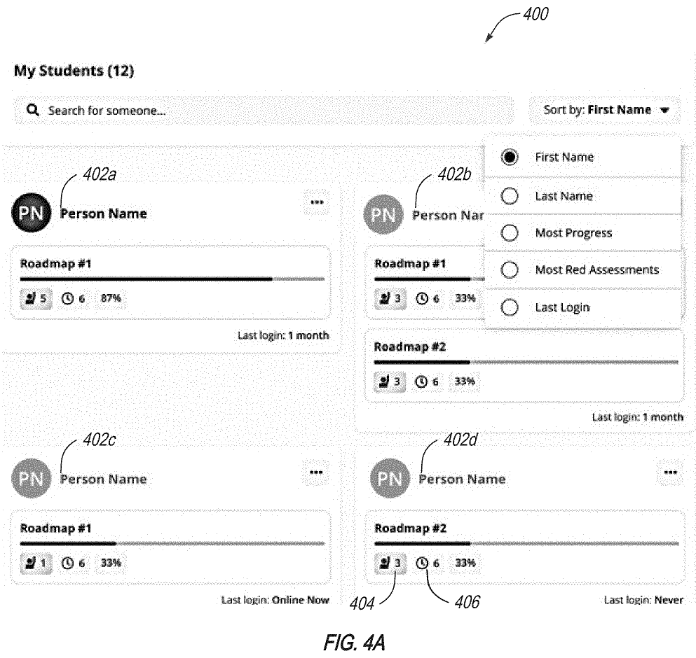

Turning to FIG. 3, in some embodiments, controller 100 is configured to coordinate display on the participant electronic device 112 of a bar 300 and sliding tab 310. When displayed on the participant electronic device 112, the sliding tab 310 may be moved by the participant along the bar 300 between a negative evaluation option region 306, the intermediate evaluation option region 304, and the positive evaluation option region 302. The bar 300 may be color-coded to transition from green at the positive evaluation option region 302 to yellow at the intermediate evaluation option region 304, and to red at negative evaluation option region 306.

The controller 100 also may be configured to coordinate display on the support partner electronic device 114 of a support partner dashboard indicating which self-evaluation metrics of the plurality of self-evaluation metrics have been completed by the participant on the participant electronic device. In some embodiments, the support partner may be supporting multiple participants, and the support partner dashboard displayed on the support partner electronic device 114 may include self-evaluation metrics for each participant of the multiple participants.

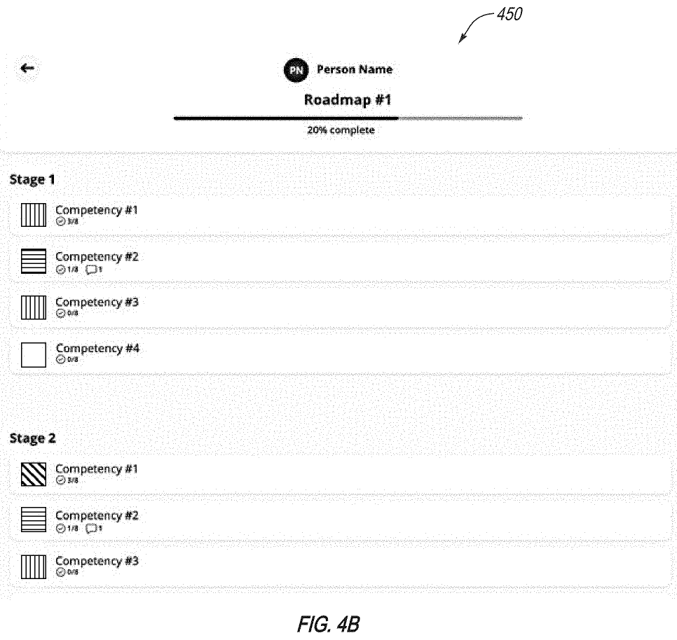

FIG. 4A, for example, is a screenshot of a support partner dashboard 400 displayed on the support partner electronic device 114 showing the progress of each of the multiple participants 402a-d. As noted above, the plurality of self-evaluation metrics may be categorized in different sequential groups (e.g., “roadmaps”). The support partner dashboard 400 may display the progress of each participant 402a-d on the different roadmaps. When a roadmap is completed (e.g., selection of all positive evaluation options) by the participant, the roadmap may temporarily or permanently disappear from the support partner dashboard 400. For example, on the support partner dashboard 400, the participant 402a has not completed roadmap #1 and has not begun roadmap #2, the participant 402b has begun and not completed both roadmap #1 and roadmap #2, the participant 402c has not completed roadmap #1 and has not begun roadmap #2, and the participant 402c has completed roadmap #1 and has not completed roadmap #2.

In some embodiments, the support partner dashboard 400 may display a help icon 404 indicating the number of negative evaluation options selected by the participant for the particular roadmap. The help icon 404 for the participant 402d, for example, indicates that the participant 402d has selected three negative evaluation options for roadmap #2. In response to the support partner selecting the help icon 404, and the controller 100 may be configured to display on the support partner electronic device 114 the particular negative evaluation options selected by the participant.

In some embodiments, the support partner dashboard 400 may display a timer icon 406 indicating the number of self-evaluation success metrics in the particular roadmap for which the participant has not selected any of the positive, negative, or intermediate evaluation options. The timer icon 406 for the participant 402d, for example, indicates that the participant 402d has not selected any of the positive, negative, or intermediate evaluation options for roadmap #2. In response to the support partner selecting the timer icon 406, and the controller 100 may be configured to display on the support partner electronic device 114 the self-evaluation success metrics in the particular roadmap for which the participant has not selected any of the positive, negative, or intermediate evaluation options.

In some embodiments, the controller 100 is configured to coordinate display on the support partner electronic device 114 of an electronic notification option (e.g., electronic nudge option) for completion of at least one of the self-evaluation metrics of the plurality of self-evaluation metrics by the participant on the participant electronic device 112. The electronic notification can be sent by the controller to the participant electronic device 112 to encourage the participant to assess himself/herself on the participant electronic device 112 for a specific success metric. For example, the controller 100 may receive electronic communication from the support partner electronic device 114 that a support partner has selected the electronic notification option and may then automatically transmit to the participant electronic device 112 an alert message or electronic notification requesting the participant select one of a positive evaluation option or a negative evaluation option for the of at least one of the self-evaluation metrics associated with the electronic notification by the success partner. The controller 100 may be configured to coordinate display of the alert message or electronic notification on the participant electronic device 112 as a pushed message or alert.

In some embodiments, the controller 100 may be configured to allow the success partner, on the success partner electronic device 114, to configure or set up an entire timeline for the controller 100 to automatically send the electronic notifications to the participant electronic device 112 at selected time intervals and/or selected dates/times at least partially based on the desired level of engagement between the participant and the success partner. In some embodiments, the controller 100 is configured to allow the participant, on the participant electronic device 100, to select a desired level of engagement, e.g., how often the participant desires to receive electronic notifications or alert messages regarding completion of one or more success metrics or roadmaps.

In some embodiments, the controller 100 may be configured to transmit or push notifications to the participant electronic device 112 for the participant to assess himself or herself at specific or predetermined times for specific or predetermined self-evaluations and/or objectives. Each self-evaluation of the plurality of self-evaluation metrics and/or objective may include unique settings for how often the participant should receive a notification on the participant electronic device 112 to assess himself or herself. In some embodiments, the controller 100 may be configured to send daily or other regularly timed notifications to the participant electronic device as a reminder to the participant of the core self-evaluation metrics the participant is striving to achieve.

In some embodiments, the controller 100 may be configured such that if the participant takes too long to engage and/or re-engage to assess himself or herself on one or more of the plurality of self-evaluation metrics, the controller 100 may determine specific assignments and/or activities in which the participant may participate. Accordingly, the controller 100 may be configured to determine that the positive evaluation option or the negative evaluation option has not been selected for one or more self-evaluation metrics for a predetermined period of time and then determine a suggested activity or assignment for the participant based on the positive evaluation option or the negative evaluation option not been selected for the one or more self-evaluation metrics for the predetermined period of time. The controller 100 may be configured to coordinate display of the suggested activity or assignment on the participant electronic device 112 when the participant takes too long to engage and/or re-engage and assess himself or herself by transmitting the specific assignments and/or activities to the participant electronic device 112, such as a push message or alert.

In some embodiments, the controller 100 is configured to receive communication from an administrator electronic device indicating how engaged the administrator would like the participant and the success partner to be. For example, the communication from the administrator electronic device may indicate that the controller 100 should send daily, weekly, or monthly notifications to the success partner and the participant to communicate. The frequency of engagement and communication may be based at least partially on the group (e.g., roadmap) of questions being selected or reviewed by the participant on the participant electronic device 112.

Turning to FIG. 4B, the controller 100 may be configured to coordinate display on the success partner electronic device 114 of a summary 450 of at least some of the plurality of self-evaluation metrics for an individual participant. For example, the summary 450 may indicate if the participant has, for each self-evaluation metric (e.g., competency) of the plurality of self-evaluation metric, selected the positive self-evaluation option (shown as vertical lines in FIG. 4B), selected the negative self-evaluation option (shown as horizontal lines in FIG. 4B), selected the intermediate evaluation option (shown as diagonal lines in FIG. 4B), or not selected any of the self-evaluation options (shown as blank in FIG. 4B). Each group of self-evaluation metrics of the plurality of self-evaluation metrics may be further subdivided into stages of self-evaluation metrics.

In some embodiments, the controller 100 is configured to coordinate display of a dashboard for the support partner or administration that includes the overall progress of multiple participants going through a plurality of identical or similar self-evaluation metrics. This dashboard may display how each participant has responded (positive, negative or intermediate) to each self-evaluation metric. This dashboard also may display which evaluation metrics have the most positive selections, the most negative selections, and/or the most intermediate selections by the participants.

A participant may select the positive evaluation option, the negative evaluation option, or the intermediate evaluation option for one or more self-evaluation metrics displayed on the participant electronic device 112. Responsive to this selection, the controller 100 may be configured to automatically receive communication from the participant electronic device 112 that the positive evaluation option, the negative evaluation option, or the intermediate evaluation option has been selected for the one or more self-evaluation metrics.

In some embodiments, the controller 100 may be configured to determine a suggested activity or experience for the participant based on the positive evaluation option, the negative evaluation option, or the intermediation evaluation option that has been selected for the one or more self-evaluation metrics. For example, depending on how a participant assesses himself or herself on the one or more self-evaluation metrics, the controller 100 may determine and/or develop (e.g., tailor) activities and/or experiences for the participant. For example, the controller 100 may determine one or more activities or suggestions for the participant based on how the participant assessed himself or herself. In some embodiments, the controller 100 may automatically and/or continuously review how other participants have responded to suggested activities and/or experiences, and then determine and/or develop activities and/or experiences for a participant based on what activities and/or experiences were most likely to lead previous participants to select positive evaluation options after completing the activities and/or experiences. Once the controller 100 has determined the suggested activity and/or experience for the participant, the controller 100 may coordinate display of the suggested activity or experience on the participant electronic device 112. For example, the controller 100 may coordinate display of an alert or other notification as a push message including the determined activity and/or suggest on the participant electronic device 100.

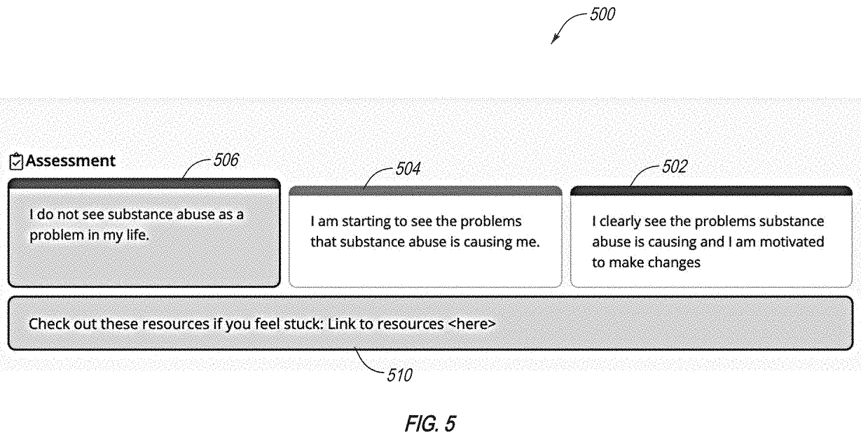

FIG. 5 shows a screenshot of a self-evaluation metric 500 displayed on the participant electronic device 112. The self-evaluation metric includes a positive evaluation option 502, an intermediate evaluation option 504, and a negative evaluation option 506. In some embodiments, responsive to the participant selecting the negative evaluation option 506, the controller 100 may be configured to display the suggested activity option 510 on the participant electronic device 112. The suggested activity option 510 may be displayed on the participant electronic device 112 as soon as the participant selects the negative evaluation option 506 or may be displayed at a later time as a push message (described above). In some embodiments, the suggested activity option 510 determined by the controller 100 may include a suggested activity of contacting a professional, such as a therapist, a counselor, a mentor, or a coach determined by the controller 100.

In some embodiments, based on the positive evaluation option or the negative evaluation option selected for the one or more self-evaluation metrics by the participant, the controller 100 may be configured to determine a ranking of the plurality of self-evaluation metrics and one or more activities likely influence the participant to select the positive evaluation option for the one or more self-evaluation metrics. For example, the controller 100 may be configured to determine a methodology to suggest the most important activities and/or assessments to transmit to the participant electronic device 112. The suggested activities and/or assessments may be ranked by the likelihood of the activities and/or assessments having a positive impact on the participant and lead the participant to select the positive self-evaluation option for one or more self-evaluation metrics of the plurality of self-evaluation metrics. At least some of the most important activities and/or assessments may be transmitted by the controller and displayed on the participant electronic device 112 in the suggested activity option 510 and/or as a message.

In some embodiments, the controller 100 may determine the participant is not progressing toward positive option selections in the roadmaps and/or plurality of self-evaluation metrics. For example, the controller 100 may be configured to receive first communication from the participant electronic device 112 on a first date that the positive evaluation option or the negative evaluation option has been selected for the one or more self-evaluation metrics and then be configured to receive second communication from the participant electronic device 112 on a second date after the first date that the positive evaluation option or the negative evaluation option has been selected for the one or more self-evaluation metrics. The controller 100 may be configured to then determine that the participant is not progressing at a preselected rate based on the positive evaluation option or the negative evaluation option selected for the one or more self-evaluation metrics on the first date and the second date. Based on this determination, the controller 100 may then be configured to determine an area in which the participant needs assistance and/or determine a professional in the area in which the participant needs assistance. The controller 100 may be configured to then transmit an option to the participant electronic device 112 for the participant to receive professional assistance from a therapist, counselor, mentor, or coach who is an expert in the area that the computer system has determined the participant needs assistance. Thus, the controller 100 may be configured to transmit an alert or other message to the participant electronic device 112 the professional in the area in which the participant needs assistance. In some embodiments, the therapist, counselor, mentor, or coach may be displayed in the suggested activity option 510. In some embodiments, the controller 100 also may be configured to transmit an alert or other message to a therapist, counselor, mentor, or coach that the participant is in need of assistance from the therapist, counselor, mentor, or coach.

In some embodiments, the controller 100 may be configured to suggest a professional (therapist, counselor, mentor, or coach) to the participant (as described above) and/or allow a consumer to choose one or more success partners that include the professional. The professional may be determined by the controller 100 based at least partially on the profile provided by the professional and which has been vetted by controller 100 and/or the administration operating the controller 100. In some embodiments, the controller 100 also may be configured to provide the participant with access to reviews provided by other participants, thereby allowing the participants to make a choice of the professional that the participant feels will be most beneficial in helping the participant achieve individual success in at least some of the plurality of self-evaluation metrics. For example, the controller 100 may be configured to coordinate display of one or more professional determined by the controller 100 to likely be good candidates for success partners with the participant. The display coordinated by the controller 100 may be after initial set up of the account for the participant, in the suggest activity option 510, and/or after the controller 100 has determined the participant is in need of assistance from one or more of the professionals.

In some embodiments, the controller 100 may be configured to collect and store data from the participants and the support partners ubiquitously. The data may include any and all data associated with the computer-based personal development system, such as demographic data for the participants and/or the success partners, frequency of engagement with the computer-based personal development system by the participants and/or the success partners, frequency of engagement between the participants and the success partners, frequency of response by the participants to notifications from the success partners, frequency and circumstances of selecting a positive self-evaluation option, frequency and circumstances of selecting a negative self-evaluation option, frequency and circumstances of selecting an intermediate self-evaluation option, final outcomes for the participants, and so on. The controller 100 may be configured to use this data to assess, diagnose, and/or recommend treatment for the participant in any of the applications of the computer-based personal development system described herein.

In some embodiments, the controller 100 may receive first communication from the participant electronic device on a first date that the positive evaluation option or the negative evaluation option has been selected for the one or more self-evaluation metrics. The controller 100 may later receive second communication from the participant electronic device on a second date after the first date that the positive evaluation option or the negative evaluation option has been selected for the one or more self-evaluation metrics. Based on at least these first and second communications that include the positive evaluation option or the negative evaluation option selected for the one or more self-evaluation metrics on the first date and the second date, the controller 100 may determine one or more suggestions for the support partner to help the participant. For example, the controller 100 may be configured to determine how the participant is progressing through the plurality of self-evaluation metrics, such as how often the participant is selecting any of the positive, negative, or intermediate self-evaluation options and/or for how many self-evaluation metrics the participant is selecting the negative self-evaluation option. Progress of the participant may be assessed by the controller 100 based on information entered on the participant electronic device 112 by the participant and/or collected automatically by the participant electronic device. Based on how the participant is progressing, the controller 100 may be configured to transmit one or more insight or tip notifications to the support partner. The one or more insight or tip notifications may provide information on how to best help the participant. The controller 100 may transmit or communicate the one or more suggestions to the support partner electronic device 114.

In some embodiments, the controller 100 may be configured to coordinate display on the participant electronic device 112 of a self-assessment. Based on the self-assessment by the participant, the controller 100 may determine a potential diagnosis and transmit a message including this potential diagnosis to the participant electronic device 112. The controller 100 also may transmit and coordinate display on the participant electronic device 112 of potential groups (e.g. roadmaps) of self-evaluation metrics that may be of use and/or interest to the participant to assist the participant in recovering, healing, improving, and/or overcoming particular issues. Depending on how the participant is progressing, other groups of self-evaluation metrics that may be better suited to assist the participant may be determined by the controller 100 and suggested to the participant on the participant electronic device 112.

In some embodiments and at any point during use of the computer-based personal development system, the controller 100 may be configured to generate, transmit, and/or display a question for the participant on the participant electronic device 112 and also generate, transmit, and/or a display the same or a similar question for the support partner on the support partner electronic device 114. The same or similar question for the support partner may be tied or related to the question that the participant answered. Based on how the participant and the support partner respond, the controller 100 may generate or determine suggestions and/or hints on how the support partner and the participant may stay engaged. The controller 100 may transmit these suggestions and/or hints to at least one of the participant electronic device 112 or the support partner electronic device 114.

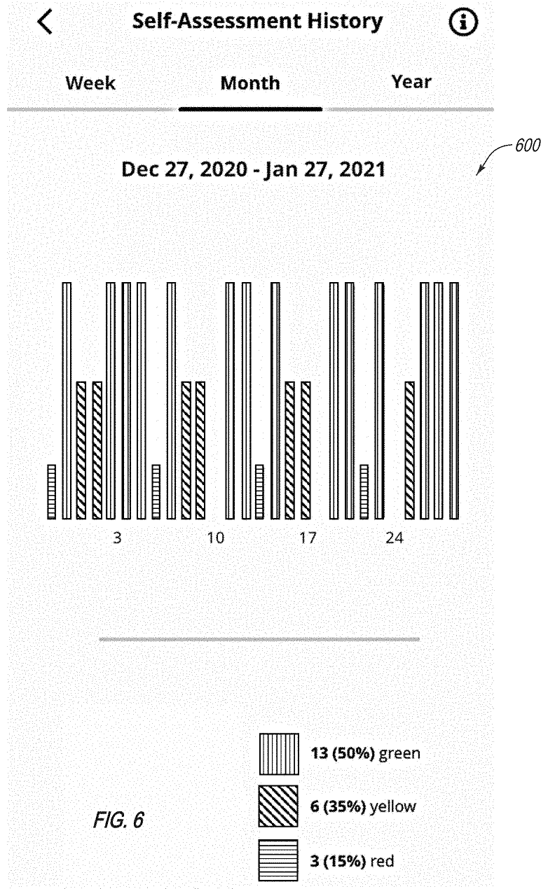

Turning to FIG. 6, in some embodiments, the controller 100 may be configured to generate and coordinate display on the participant electronic device 112 (and/or the success partner electronic device 114) of a progress report 600 that provides one or more metrics of progress of the participant. The controller may automatically transmit the progress report 600 to the support partner electronic device 114. The progress report 600 may include a bar graph over a period of time (such as a week, month, or year) indicating how the many times the participant has selected the positive evaluation option, the negative evaluation option, and the intermediate evaluation option during each of the multiple segments (days, weeks, months) of time that make up the period (weeks, months, year) of time. For example, the example progress report 600 of FIG. 6 shows how many times the participant selected the positive evaluation option, the negative evaluation option, and the intermediate evaluation option during each week of a particular month. The progress report also may show a total percentage of positive evaluation options, negative evaluation options, and intermediate evaluation options selected by the participant during the period of time. For example, the progress report 600 of FIG. 6 shows the positive (or green) evaluation option constitutes 50% of the self-evaluation metrics selected by the participant, the intermediate (or yellow) evaluation option constitutes 35% of the self-evaluation metrics selected by the participant, and the negative (or red) evaluation option constitutes 15% of the self-evaluation metrics selected by the participant. The controller 100 also may be configured to automatically generate tips for how the support partner may best help the participant based on the progress of the participant, as shown on the progress report 600.

In some embodiments, the controller 100 may be configured to generate a dashboard on the participant electronic device 112. The dashboard displayed on the participant electronic device 112 may include a visual representation of the progress made by the participant. For example, the dashboard on the participant electronic device 112 may visually show that the participant is climbing a mountain and that it takes small steps every day to get there.

Based on at least one group (e.g. roadmap) of the plurality of self-evaluation metrics on which the participant is focusing is working, the controller 100 may automatically determine the likelihood of a relapse by the participant. In operation, the controller 100 may be configured to receive communication from the participant electronic device 112 that the positive evaluation option or the negative evaluation option has been selected for the one or more self-evaluation metrics. The controller 100 may be configured to then determine a likelihood that the participant will select the negative evaluation option or fail to select either the positive evaluation option or the negative evaluation option within a predetermined period of time (such as a day, week, or month). If the likelihood that the participant will select the negative evaluation option or fail to select the positive evaluation option, the intermediate evaluation option, or the negative evaluation option (e.g., fail to select any option) within a predetermined period of time is greater than a predetermined threshold, the controller 100 may automatically transmit or push an alert message to the support partner electronic device 114 that the participant is likely to select the negative evaluation option or fail to select the positive evaluation option, the intermediate evaluation option, or the negative evaluation option within a predetermined period of time. In some embodiments, the controller 100 generates the alert message and pushes the alert message to the success partner computing device to alert the success partner when the likelihood of relapse meets the predetermined threshold. For example, the predetermined threshold may include a 90% likelihood of relapse by the participant, and the controller may push an alert to the success partner electronic device 114 that says, for example: “Did you know your participant has a 90% chance of relapse if you don't reach out to them in the next 48 hours?”

In some embodiments, the controller 100 may receive communication from the participant electronic device 112 that includes a facial video, an image, and/or an audio recording of the participant. The controller may be configured to review the facial video, the image, and/or the audio recording of the participant and determine a mental status of the participant based on this review. For example, the controller 100 may be configured to integrate video chat and use facial recognition to identify if the participant is stressed, happy, depressed, and/or anxious. Based on what the facial recognition software detects, the controller 100 may be is configured to determine a suggested activity for the participant based on the mental status. For example, the controller 100 may determine and provides suggestions for the success partner and/or the participant on what to do in response to the detected mood. The suggested activity may be transmitted by the controller 100 to at least one of the support partner electronic device 114 and/or the participant electronic device 112.

The controller 100 may be configured to measure engagement by the participant outside of the plurality of self-evaluation metrics. In some embodiments, the controller 100 is configured to perform an analysis of one or more of a facial video of the participant, audio of the participant, and/or social media content of the participant. For example, the controller 100 may be configured to determine and/or collect data points such as facial recognition by the controller 100 on video chat, voice assessments by the controller 100 on video or audio chat, how often the participant comes into work late, how often the participant chats with other employees, how long the participant's lunch breaks are, and/or social media posts by the participant. The controller 100 may be configured to use these data points to measure engagement by the participant with at least some of the plurality of self-evaluation metrics. For example, the controller 100 may be configured to select the positive evaluation option or the negative evaluation option for the one or more self-evaluation metrics for the participant based on the analysis of the one or more of the facial video of the participant, the audio of the participant, or the social media content of the participant.

In some embodiments, the controller 100 is configured to allow at least one of the participant or the support partner to send electronic requests to have a third-party measure the engagement of the participant with the plurality of self-evaluation metrics. For example, a therapist (as a support partner) may desire that a parent or teacher assess a child (as a participant) with which the therapist is working on the plurality of self-evaluation metrics. The controller 100 may be configured to transmit a request to a third-party electronic device of the third-party. The request may include one or more engagement evaluations displayed on the third-party electronic device, with the one or more engagement evaluations relating to engagement by the participant with the plurality of self-evaluation metrics. The controller 100 may receive communication from the third-party electronic device including the one or more engagement evaluations completed by the third-party on the third-party electronic device.

In some embodiments, the controller 100 may be configured to generate, transmit, and/or display features on at least one of the participant electronic device 112, the support partner electronic device 114, and/or the third party electronic device (e.g., parent or teach electronic device) that make the participant feel valued, appreciated, recognized. In some embodiments, the controller 100 may be configured to generate, transmit, and/or display features on at least one of the participant electronic device 112, the support partner electronic device, and/or the third party electronic device (e.g., parent or teach electronic device) that incentivize the participant, such as through gamification of the plurality of self-evaluation metrics. In some embodiments, the controller 100 may be configured to coordinate display of a profile picture of participant on the screen of the participant electronic device 112 or the support partner electronic device 114, next to the assessment of the participant. This display of the profile picture may help the participant visually see their assessment.

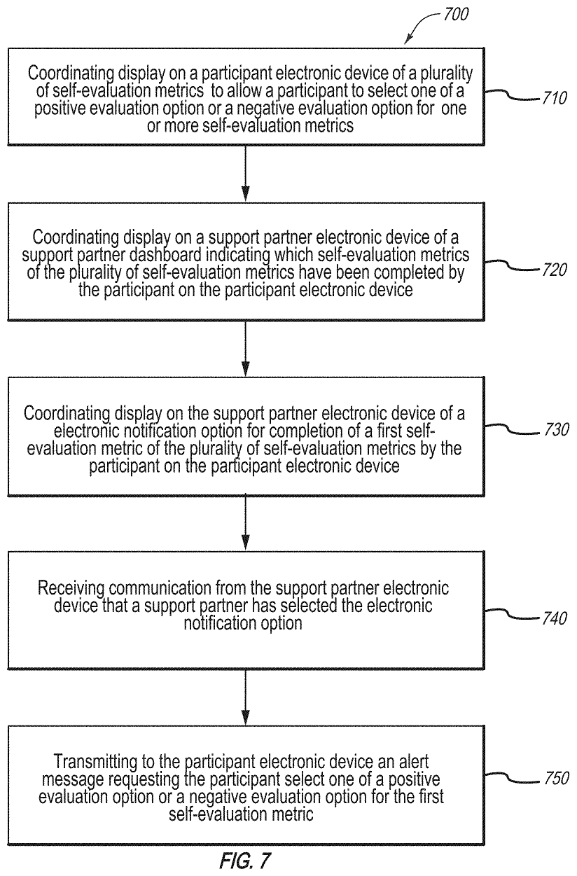

FIG. 7 is a flow diagram of a method 700 for improving electronic engagement between a participant and a support partner, according to an embodiment. The method 700 may include any aspect or act performed by the controller 100, the participant electronic device 112, and/or the support partner electronic device 114. In some embodiments, the method 700 includes and act 710 of coordinating display on a participant electronic device of a plurality of self-evaluation metrics. One or more self-evaluation metrics of the plurality of self-evaluation metrics may include at least a positive evaluation option and a negative evaluation option displayed on the participant electronic device and configured to allow a participant to select one of the positive evaluation option or the negative evaluation option for the one or more self-evaluation metrics.

In some embodiments, the method 700 includes an act 720 of coordinating display on a support partner electronic device of a support partner dashboard indicating which self-evaluation metrics of the plurality of self-evaluation metrics have been completed by the participant on the participant electronic device. In some embodiments, the method 700 includes an act 730 of coordinating display on the support partner electronic device of an electronic notification option for completion of a first self-evaluation metric of the plurality of self-evaluation metrics by the participant on the participant electronic device. In some embodiments, the method 700 includes an act 740 of receiving communication from the support partner electronic device that a support partner has selected the electronic notification option. The method 700 also includes an act 750 of transmitting to the participant electronic device an alert message requesting the participant select one of a positive evaluation option or a negative evaluation option for the first self-evaluation metric.

In some embodiments, the method 700 includes an act receiving communication from the participant electronic device that the positive evaluation option or the negative evaluation option has been selected for the one or more self-evaluation metrics. In these and other embodiments, the method 700 may include determining a suggested activity or experience for the participant based on the positive evaluation option or the negative evaluation option that has been selected for the one or more self-evaluation metrics and coordinating display of the suggested activity or experience on the participant electronic device.

In some embodiments, the method 700 includes determining that the positive evaluation option or the negative evaluation option has not been selected for the one or more self-evaluation metrics for a predetermined period of time. In these and other embodiments, the method 700 may include determining a suggested activity or assignment for the participant based on the positive evaluation option or the negative evaluation option not been selected for the one or more self-evaluation metrics for the predetermined period of time. The method 700 also may include coordinating display of the suggested activity or assignment on the participant electronic device.

In some embodiments, the method 700 includes receiving communication from the participant electronic device that the positive evaluation option or the negative evaluation option has been selected for the one or more self-evaluation metrics and determining a likelihood that the participant will select the negative evaluation option or fail to select either the positive evaluation option or the negative evaluation option within a predetermined period of time. If the likelihood is greater than a predetermined threshold, the method 700 may include automatically transmitting an alert message to the support partner electronic device that the participant is likely to select the negative evaluation option or fail to select either the positive evaluation option or the negative evaluation option within the predetermined period of time.

In some embodiments, the method 700 may include an act of receiving communication from the participant electronic device including a facial video of the participant and determining a mental status of the participant based on the facial video of the participant. In these and other embodiments, the method 700 may include determining a suggested activity for the participant based on the mental status and transmitting a message including the suggested activity to at least one of the participant electronic device or the success partner electronic device.

In some embodiments, the method 700 includes an act of receiving first communication from the participant electronic device on a first date that the positive evaluation option or the negative evaluation option has been selected for the one or more self-evaluation metrics. The method 700 also may include receiving second communication from the participant electronic device on a second date after the first date that the positive evaluation option or the negative evaluation option has been selected for the one or more self-evaluation metrics. In these and other embodiments, the method 700 may include determining the participant is not progressing at a preselected rate based on the positive evaluation option or the negative evaluation option selected for the one or more self-evaluation metrics on the first date and the second date and determining an area in which the participant needs assistance based on the positive evaluation option or the negative evaluation option that has been selected for the one or more self-evaluation metrics on the first date or the second date. The method 700 also may include determining a professional in the area in which the participant needs assistance and transmitting a message including the professional in the area in which the participant needs assistance to the participant electronic device.

In some embodiments, the method 700 includes an act of receiving first communication from the participant electronic device on a first date that the positive evaluation option or the negative evaluation option has been selected for the one or more self-evaluation metrics and receiving second communication from the participant electronic device on a second date after the first date that the positive evaluation option or the negative evaluation option has been selected for the one or more self-evaluation metrics. In these and other embodiments, the method 700 may include determining one or more suggestions for the support partner to help the participant based on the positive evaluation option or the negative evaluation option selected for the one or more self-evaluation metrics on the first date and the second date. The method 700 may also include transmitting a message including the one or more suggestions to the support partner electronic device.

In some embodiments, the method 700 includes transmitting a request to a third-party electronic device, the request including one or more engagement evaluations relating to engagement by the participant with the plurality of self-evaluation metrics. In these and other embodiments, the method 700 may include receiving communication from the third-party electronic device including the one or more engagement evaluations completed by the third-party.

In some embodiments, the method 700 includes performing an analysis of one or more of a facial video of the participant, audio of the participant, social media content of the participant. In these and other embodiments, the method 700 may include selecting the positive evaluation option or the negative evaluation option for the one or more self-evaluation metrics for the participant based on the analysis of the one or more of the facial video of the participant, the audio of the participant, or the social media content of the participant.

In some embodiments, the method 700 includes receiving communication from the participant electronic device that the positive evaluation option or the negative evaluation option has been selected for the one or more self-evaluation metrics. In these and other embodiments, the method 700 may include, based on the positive evaluation option or the negative evaluation option selected for the one or more self-evaluation metrics by the participant, determining a ranking of the plurality of self-evaluation metrics and one or more activities likely influence the participant to select the positive evaluation option for the one or more self-evaluation metrics. The method 700 also may include transmitting the ranking to the participant communication device.

The acts of the method 700 described above are for illustrative purposes. For example, the acts of the method 700 can be performed in different orders, split into multiple acts, modified, supplemented, or combined. In an embodiment, one or more of the act of the method 700 can be omitted from the method 700.

As used herein, the term “about” or “substantially” refers to an allowable variance of the term modified by “about” or “substantially” by ±10% or ±5%. Further, the terms “less than,” “or less,” “greater than,” “more than,” or “or more” include, as an endpoint, the value that is modified by the terms “less than,” “or less,” “greater than,” “more than,” or “or more.”

While various aspects and embodiments have been disclosed herein, other aspects and embodiments are contemplated. The various aspects and embodiments disclosed herein are for purposes of illustration and are not intended to be limiting.

What is claimed is:

1. A system, comprising:
a processor; and
a memory coupled to the processor and containing computer-executable instructions that, when executed by the processor, cause the processor to perform acts of:
coordinating display on a participant electronic device of a plurality of self-evaluation metrics, one or more self-evaluation metrics of the plurality of self-evaluation metrics including at least a positive evaluation option and a negative evaluation option displayed on the participant electronic device and configured to allow a participant to select one of the positive evaluation option or the negative evaluation option for the one or more self-evaluation metrics;
coordinating display on a support partner electronic device of a support partner dashboard indicating which self-evaluation metrics of the plurality of self-evaluation metrics have been completed by the participant on the participant electronic device;
coordinating display on the support partner electronic device of an electronic notification option for completion of a first self-evaluation metric of the plurality of self-evaluation metrics by the participant on the participant electronic device;
receiving communication from the support partner electronic device that a support partner has selected the electronic notification option; and
transmitting to the participant electronic device an alert message requesting the participant select one of a positive evaluation option or a negative evaluation option for the first self-evaluation metric.

2. The system of claim 1, wherein the computer-executable instructions, when executed by the processor, cause the processor to perform acts of:
receiving communication from the participant electronic device that the positive evaluation option or the negative evaluation option has been selected for the one or more self-evaluation metrics;
determining a suggested activity or experience for the participant based on the positive evaluation option or the negative evaluation option that has been selected for the one or more self-evaluation metrics; and
coordinating display of the suggested activity or experience on the participant electronic device.

3. The system of claim 1, wherein the computer-executable instructions, when executed by the processor, cause the processor to perform acts of:
determining that the positive evaluation option or the negative evaluation option has not been selected for the one or more self-evaluation metrics for a predetermined period of time;
determining a suggested activity or assignment for the participant based on the positive evaluation option or the negative evaluation option not been selected for the one or more self-evaluation metrics for the predetermined period of time; and
coordinating display of the suggested activity or assignment on the participant electronic device.

4. The system of claim 1, wherein the computer-executable instructions, when executed by the processor, cause the processor to perform acts of:
receiving communication from the participant electronic device that the positive evaluation option or the negative evaluation option has been selected for the one or more self-evaluation metrics;
determining a likelihood that the participant will select the negative evaluation option or fail to select either the positive evaluation option or the negative evaluation option within a predetermined period of time; and
if the likelihood is greater than a predetermined threshold, automatically transmitting an alert message to the support partner electronic device that the participant is likely to select the negative evaluation option or fail to select either the positive evaluation option or the negative evaluation option within the predetermined period of time.

5. The system of claim 1, wherein the computer-executable instructions, when executed by the processor, cause the processor to perform acts of:
receiving communication from the participant electronic device including a facial video of the participant;
determining a mental status of the participant based on the facial video of the participant;
determining a suggested activity for the participant based on the mental status; and
transmitting a message including the suggested activity to at least one of the participant electronic device or the success partner electronic device.

6. The system of claim 1, wherein the computer-executable instructions, when executed by the processor, cause the processor to perform acts of:
receiving first communication from the participant electronic device on a first date that the positive evaluation option or the negative evaluation option has been selected for the one or more self-evaluation metrics;
receiving second communication from the participant electronic device on a second date after the first date that the positive evaluation option or the negative evaluation option has been selected for the one or more self-evaluation metrics;
determining the participant is not progressing at a preselected rate based on the positive evaluation option or the negative evaluation option selected for the one or more self-evaluation metrics on the first date and the second date;
determining an area in which the participant needs assistance based on the positive evaluation option or the negative evaluation option that has been selected for the one or more self-evaluation metrics on the first date or the second date;
determining a professional in the area in which the participant needs assistance; and
transmitting a message including the professional in the area in which the participant needs assistance to the participant electronic device.

7. The system of claim 1, wherein the computer-executable instructions, when executed by the processor, cause the processor to perform acts of:
receiving first communication from the participant electronic device on a first date that the positive evaluation option or the negative evaluation option has been selected for the one or more self-evaluation metrics;
receiving second communication from the participant electronic device on a second date after the first date that the positive evaluation option or the negative evaluation option has been selected for the one or more self-evaluation metrics;
determining one or more suggestions for the support partner to help the participant based on the positive evaluation option or the negative evaluation option selected for the one or more self-evaluation metrics on the first date and the second date; and
transmitting a message including the one or more suggestions to the support partner electronic device.

8. The system of claim 1, wherein the computer-executable instructions, when executed by the processor, cause the processor to perform acts of:
transmitting a request to a third-party electronic device, the request including one or more engagement evaluations relating to engagement by the participant with the plurality of self-evaluation metrics; and
receiving communication from the third-party electronic device including the one or more engagement evaluations completed by the third-party.

9. The system of claim 1, wherein the computer-executable instructions, when executed by the processor, cause the processor to perform acts of:
performing an analysis of one or more of a facial video of the participant, audio of the participant, social media content of the participant; and
selecting the positive evaluation option or the negative evaluation option for the one or more self-evaluation metrics for the participant based on the analysis of the one or more of the facial video of the participant, the audio of the participant, or the social media content of the participant.

10. The system of claim 1, wherein the computer-executable instructions, when executed by the processor, cause the processor to perform acts of:
receiving communication from the participant electronic device that the positive evaluation option or the negative evaluation option has been selected for the one or more self-evaluation metrics;
based on the positive evaluation option or the negative evaluation option selected for the one or more self-evaluation metrics by the participant, determining a ranking of the plurality of self-evaluation metrics and one or more activities likely influence the participant to select the positive evaluation option for the one or more self-evaluation metrics; and
transmitting a message including the ranking to the participant communication device.

11. A computer-implemented method, the computer-implemented method comprising:
coordinating display on a participant electronic device of a plurality of self-evaluation metrics, one or more self-evaluation metrics of the plurality of self-evaluation metrics including at least a positive evaluation option and a negative evaluation option displayed on the participant electronic device and configured to allow a participant to select one of the positive evaluation option or the negative evaluation option for the one or more self-evaluation metrics;
coordinating display on a support partner electronic device of a support partner dashboard indicating which self-evaluation metrics of the plurality of self-evaluation metrics have been completed by the participant on the participant electronic device;
coordinating display on the support partner electronic device of an electronic notification option for completion of a first self-evaluation metric of the plurality of self-evaluation metrics by the participant on the participant electronic device;
receiving communication from the support partner electronic device that a support partner has selected the electronic notification option; and
transmitting to the participant electronic device an alert message requesting the participant select one of a positive evaluation option or a negative evaluation option for the first self-evaluation metric.

12. The computer-implemented method of claim 11, further comprising:
receiving communication from the participant electronic device that the positive evaluation option or the negative evaluation option has been selected for the one or more self-evaluation metrics;
determining a suggested activity or experience for the participant based on the positive evaluation option or the negative evaluation option that has been selected for the one or more self-evaluation metrics; and
coordinating display of the suggested activity or experience on the participant electronic device.

13. The computer-implemented method of claim 11, further comprising:
determining that the positive evaluation option or the negative evaluation option has not been selected for the one or more self-evaluation metrics for a predetermined period of time;
determining a suggested activity or assignment for the participant based on the positive evaluation option or the negative evaluation option not been selected for the one or more self-evaluation metrics for the predetermined period of time; and
coordinating display of the suggested activity or assignment on the participant electronic device.

14. The computer-implemented method of claim 11, further comprising:
receiving communication from the participant electronic device that the positive evaluation option or the negative evaluation option has been selected for the one or more self-evaluation metrics;
determining a likelihood that the participant will select the negative evaluation option or fail to select either the positive evaluation option or the negative evaluation option within a predetermined period of time; and
if the likelihood is greater than a predetermined threshold, automatically transmitting an alert message to the support partner electronic device that the participant is likely to select the negative evaluation option or fail to select either the positive evaluation option or the negative evaluation option within the predetermined period of time.

15. The computer-implemented method of claim 11, further comprising:
receiving communication from the participant electronic device including a facial video of the participant;
determining a mental status of the participant based on the facial video of the participant;
determining a suggested activity for the participant based on the mental status; and
transmitting a message including the suggested activity to at least one of the participant electronic device or the success partner electronic device.

16. The computer-implemented method of claim 11, further comprising:
receiving first communication from the participant electronic device on a first date that the positive evaluation option or the negative evaluation option has been selected for the one or more self-evaluation metrics;
receiving second communication from the participant electronic device on a second date after the first date that the positive evaluation option or the negative evaluation option has been selected for the one or more self-evaluation metrics;
determining the participant is not progressing at a preselected rate based on the positive evaluation option or the negative evaluation option selected for the one or more self-evaluation metrics on the first date and the second date;
determining an area in which the participant needs assistance based on the positive evaluation option or the negative evaluation option that has been selected for the one or more self-evaluation metrics on the first date or the second date;
determining a professional in the area in which the participant needs assistance; and
transmitting a message including the professional in the area in which the participant needs assistance to the participant electronic device.

17. The computer-implemented method of claim 11, further comprising:
receiving first communication from the participant electronic device on a first date that the positive evaluation option or the negative evaluation option has been selected for the one or more self-evaluation metrics;
receiving second communication from the participant electronic device on a second date after the first date that the positive evaluation option or the negative evaluation option has been selected for the one or more self-evaluation metrics;
determining one or more suggestions for the support partner to help the participant based on the positive evaluation option or the negative evaluation option selected for the one or more self-evaluation metrics on the first date and the second date; and
transmitting a message including the one or more suggestions to the support partner electronic device.

18. The computer-implemented method of claim 11, further comprising:
transmitting a request to a third-party electronic device, the request including one or more engagement evaluations relating to engagement by the participant with the plurality of self-evaluation metrics; and
receiving communication from the third-party electronic device including the one or more engagement evaluations completed by the third-party.

19. The computer-implemented method of claim 11, further comprising:
performing an analysis of one or more of a facial video of the participant, audio of the participant, social media content of the participant; and
selecting the positive evaluation option or the negative evaluation option for the one or more self-evaluation metrics for the participant based on the analysis of the one or more of the facial video of the participant, the audio of the participant, or the social media content of the participant.

20. The computer-implemented method of claim 11, further comprising:
receiving communication from the participant electronic device that the positive evaluation option or the negative evaluation option has been selected for the one or more self-evaluation metrics;
based on the positive evaluation option or the negative evaluation option selected for the one or more self-evaluation metrics by the participant, determining a ranking of the plurality of self-evaluation metrics and one or more activities likely influence the participant to select the positive evaluation option for the one or more self-evaluation metrics; and
transmitting a message including the ranking to the participant communication device.
